(19) United States
(12) Patent Application Publication
(10) Pub. No.: US 2007/0102027 A1
(43) Pub. Date: May 10, 2007

(54) Washing device and aqua stopping device for the same

(76) Inventor: Jong Chul Bang, Gyeongsangnam-do (KR)

Correspondence Address: MCKENNA LONG & ALDRIDGE LLP, 1900 K STREET, NW, WASHINGTON, DC, 20006, US

(21) Appl. No.: 10/579,976

(22) PCT Filed: Sep. 23, 2005
(86) PCT No.: PCT/KR05/03166

§ 371 Date: May 22, 2006

(30) Foreign Application Priority Data
Sep. 24, 2004 (KR) 10-2004-0076747

(51) Int. Cl. B08B 3/00

(52) U.S. Cl. 134/43; 134/56 R

(57) ABSTRACT

An aqua stopping device (200) for washing device (100) is provided. The aqua stopping device (200) includes a valve body (210), at least one valve (280), a signal wire (271), a connecting wire (271), a connecting portion (272), an inner case (260), an outer case (250). The valve body (210) has a passage formed within. The at least one valve (280) opens and closes the passage. The signal wire (271) is connected to a terminal of the valve (280). The connecting wire (271) is connected to the signal wire (271). The connecting portion (272) is the portion where the signal wire (271) and the connecting wire (271) connecte. The inner case (260) encloses at least the connecting portion. The outer case (250) is provided at the exterior of the inner case (260). The inventive aqua stopping device (200) reduces manufacturing cost and time, and also the weight of the device to make handling thereof easier.

### TECHNICAL FIELD

The present invention relates to a washing device, and more particularly, to an aqua stopping device for a washing device. Specifically, when used with a dishwasher, washing machine, or other washing devices, in the event that the washing device leaks water, the aqua stopping device senses the leakage and quickly blocks it.

### BACKGROUND ART

A washing machine is a device that uses an external water supply to wash objects.

Examples of the washing machine can be a washing machine or a dishwasher. Because this type of washing device requires a constant supply of water from the outside, it is usually connected to a faucet. Water from the external water source is selectively supplied to the washing device during its operation by opening an attached valve.

The washing device has a tub forming a predetermined space to store objects and subject them to wash water for washing. A connecting tube connects the tub and the faucet, allowing water to flow from the faucet into the tub. Furthermore, a predetermined valve is installed at the connecting portion between the tub and the connecting tube.

When needed, this valve opens to allow water to flow into the tub.

Because the tub is a part that holds water, if the tub or a part attached to the tub is damaged, water can leak from the washing device to the outer surroundings.

When such leak occurs, water is continuously supplied from the faucet, causing flooding. Therefore, an aqua stopping device is installed to quickly block the supply of water in the event of a leak. Suoh an aqua stopping device is usually installed at the connecting portion between the connecting tube and the faucet.

In further detail, the aqua stopping device includes a housing, a valve disposed inside the housing for controlling water flow through a passage by opening and closing, and a signal wire connected to an end of the valve. The other end of the signal wire is connected to a predetermined sensor disposed on the floor of the washing device that senses leaks. With this device in place, when water leaks in the washing device, the sensor senses the leak and sends a predetermined signal along the signal wire to the valve. When the valve receives the signal, it closes the passage in the aqua stopping device, preventing further flow of water from the faucet.

The valve is operated via a predetermined electrical wire similar to the signal wire. Because a passage for water flow is disposed adjacent to the valve, there is always the possibility of the current flowing through the signal wire leaking. Due to this potential hazard, the interior of the housing is commonly filled in its entirety with a resin or similar material, and the valve also has a filling on its outer surfaces (with the exception of the moving portion that seals the water passage). Thus, even if water should enter the housing through the periphery of the portion sealing the passage, the signal wires do not come into contact with the water, thus preventing the possibility of current leakage.

However, when a filling fills the entire inner cavity of the aqua stopping device, the manufacturing cost of the aqua stopping device rises, more time is needed to manufacture the product, and the device's weight increases, making it user-unfriendly.

### DISCLOSURE OF THE INVENTION

Technical Problem

An object of the present invention is to provide a washing device and an aqua stopping device for the washing device that enables an increase in production of the aqua stopping device by reducing its manufacturing cost and time.

Another object of the present invention is to provide a washing device and an aqua stopping device for the washing device that make the aqua stopping device user-friendly by reducing its weight.

Technical Solution

According to an aspect of the present invention, a washing device includes: a tub for holding wash water and articles to wash therein for washing the articles to wash; a connecting tube for supplying water to the tub; a leak detector provided at an exterior of the tub for detecting leaks; and an aqua stopping device for operating to block a supply of water according to a detection signal from the leak detector, the aqua stopping device being filled with a filler only at wire connecting portions in an interior thereof, the interior being otherwise empty.

According to another aspect of the present invention, a washing device includes: a tub for holding wash water and articles to wash therein for washing the articles to wash; a connecting tube for supplying water to the tub; a leak detector provided at an exterior of the tub for detecting leaks; and an aqua stopping device for operating to block a supply of water according to a detection signal from the leak detector; wherein the aqua stopping device includes an inner case having a wire connecting portion in an interior thereof for preventing water from contacting the wire connecting portion, a valve for opening and closing a passage according to the detection signal, and an outer case disposed at a distant exterior of the inner case and defining an empty interior space.

According to a further another aspect of the present invention, an aqua stopping device for a washing device includes: a valve body including a passage within; at least one valve for opening and closing the passage; a signal wire connected to a terminal of the valve; a connecting wire connected to the signal wire and extending a pre-determined distance therefrom; a connecting portion provided at a portion connecting the signal wire and the connecting wire; an inner case enclosing at least the connecting portion; and an outer case provided at an exterior of the inner case.

According to still further aspect of the present invention, an aqua stopping device for a washing device includes: a valve body including a passage within; at least one solenoid valve for opening and closing the passage; a signal wire connected to a terminal of the solenoid valve; a connecting wire connected to the signal wire and extending outward; a connecting portion formed at a connection of the signal wire and the connecting wire; a filler for insulating at least the connecting portion from an outside; and an outer case spaced from the filler and including an empty space inside.

Advantageous Effects

The present invention reduces the manufacturing cost, manufacturing time, and weight of the aqua stopping device.

It makes it easier to handle the aqua stopping device during installation, etc. due to its lighter weight.

### BRIEF DESCRIPTION OF THE DRAWINGS

FIG. 1 is a side view of a dishwasher according to the present invention; and

FIG. 2 is a sectional view of an aqua stop device according to the present invention.

### BEST MODE FOR CARRYING OUT THE INVENTION

Hereinafter, preferred embodiments according to the present invention will be described in detail with reference to the accompanying drawings. Although the following embodiments relate to an exemplary dishwasher, the present invention is not limited thereto, and may include any device such as a washing machine that operates through an attachment to a faucet or other continicus water supply.

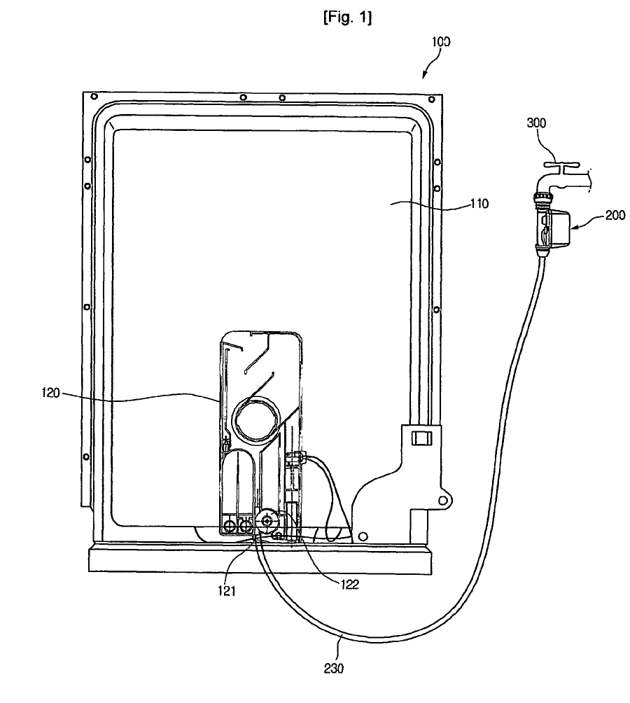

FIG. 1 is a side view of a dishwasher according to the present invention, showing an exposed side of the dishwasher from which a side panel has been removed to reveal an air brake installed therein.

Referring to FIG. 1, the dishwasher 100 according to the present invention includes a tub 110 forming the outer shape of the dishwasher 100 and a wash compartment within, a flow meter 122 installed at a side of the tub 110 to measure the amount of wash water flowing into the wash compartment, a water supply connecting port 121 connected to the bottom of the flow meter 122 to admit a flow of wash water from the water supply, an air brake 120 having a hole formed thereon to vent hot steam out from inside the wash compartment during a wash cycle, an aqua stopping device 200 connected to the end of a faucet or similar water supply 300 to forcibly block the flow of wash water when a leak occurs, and a connecting tube 230 connecting the aqua stopping device 200 to the water supply connecting port 121 to supply wash water to the inside of the tub 11Q

The above dishwasher further includes a floater switch or similar leak detector located at the bottom of the dishwasher 100 to detect leaks. The leak detector is not limited to being a floater switch, and can be a conductivity sensor that detects leaks by sensing a conductivity change when electrodes contact water or a turbidity sensor that detects leaks by sensing the turbidity of leaked water. Also, the location of the leak detector can be varied, and the leak detector may be installed in an area that leaking water in the dishwasher 100 will most likely accumulate in or an area prone to leakage.

A brief explanation of the operation of the above dishwasher 100 will now be given.

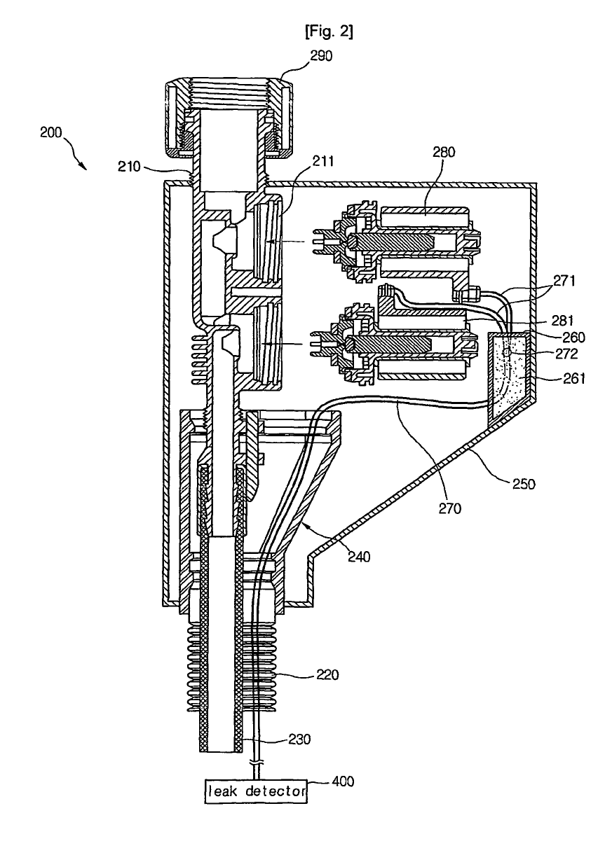

During the process where wash water flows past the aqua stopping device 200 through the inside of the air brake 120 into the tub, if a leak occurs inside a portion of the tub or an alternate portion of the dishwasher, the leak is detected by the leak detector. When the leak detector detects the leak, a leak detection signal is sent to the aqua stopping device 20Q A solenoid valve 280<jn FIG. 2) installed in the aqua stopping device 200 operates according to the leak detection signal and closes the inside passage of the aqua stopping device 2OQ When the aqua stopping device 200 closes, the wash water flowing through the connecting tube 230 cannot flow further and enter the inside of the dishwasher. Subsequently, the water leaking inside the dishwasher stops leaking.

A detailed explanation of the structure and function of the aqua stopping device 200 will now be given with reference to the drawings.

FIG. 2 is a sectional view of an aqua stop device according to the present invention.

Referring to FIG. 2, the aqua stopping device 200 according to the present invention includes a valve body 210 of a predetermined length forming a passage for wash water to flow through, a nut 290 disposed on top of the valve body 210 to connect to the water supply 300 that supplies wash water to the aqua stopping device 200, and a connecting tube 230 installed at the lower end of the valve body 210 to relay the wash water that has passed through the valve body 210 to the interior of the wash compartment of the dishwasher 1OQ

The aqua stopping device further includes at least one solenoid valve for closing the interior passage of the valve body 210 to immediately stop the supply of wash water when a leak occurs inside the washing device. In a first embodiment of the present invention, two solenoid valves are installed along the valve body 210 one above the other, in order to increase the reliability of the aqua stopping device 2OQ The two solenoid valves will henceforth be referred to as an upper and a lower valve 280 and 281. However, the number and location of the solenoid valves are not limited to this embodiment in the present invention, and may take a variety of forms depending on the type of aqua stopping device 2OQ Besides the solenoid valve, the aqua stopping device 200 may include a built-in water flow meter, etc.

The aqua stopping device 200 further includes an outer rube 220 covering the exterior of the connecting tube 230, so that the aqua stopping device 200 has a two-hose structure. Specifically, even if the connecting tube 230 should develop a leak, the outer tube 220 ensures that leaking wash water is contained and does not fall and wet the floor. The connecting tube 230, in light of its relation to the outer tube 220, may be alternatively referred to as an inner tube.

The aqua stopping device also includes a coupling portion 240 that couples the outer tube 220 with the valve body 210 and an outer case 250 covering the solenoid upper and lower valves 280 and 281 to protect them from external shocks. On a side of the valve body 210 is a threaded valve seat 211 for insertingly mounting the upper and lowervalves 280 and 281.

Formed on a side of the upper valve 280 and the lower valve 281 are terminals for receiving external electricity. A pair of connecting wires 271 are connected to the terminal for relaying a leakage signal, and the pair of connecting wires 271 converge to form a signal wire 27Q The signal wire and the connecting wires 271 are connected at a connecting portion 272. The connecting portion 272 is formed inside a small inner case 260 installed inside the outer case 250, in order to prevent current leakage or short circuiting.

Specifically, a pair of connecting wires 271 and a signal wire 270 are connected inside the inner case 260, where the point of connection is the connecting portion 272. To prevent current leakage or other electrical malfunctions occurring at the connecting portion 272, the inside of the inner case is filled with an epoxy or similar filler 261. Accordingly, water does not come into contact with the connecting portion 272, so that current leakage from the connecting portion 272 does not occur.

Thus, the outer case 250, with the exception of the inner case 260, is empty. Because only the inside of the inner case 260 is filled with filler, the amount of filler required decreases and the manufacturing cost decreases. The use of less filler decreases manufacturing time and also the overall weight of the product for ease of handling.

The signal wire 270 extends out from the inner case 260, through the coupling portion 240, and between the inner surface of the outer tube 220 and the outer surface of the connecting tube 230, to finally connect to the leak detector 4OQ When the leak detector 400 detects the occurrence of a leak, it sends a leakage signal to operate the aqua stopping device 200 to shut off the water from the water supply 30Q An explanation of the leak detector 400 connected directly to the aqua stopping device 200 has been given. However, the present invention is not thus limited, and may include the leak detector 400 connected directly to the control unit of the dishwasher, whereby the signal wire 270 is connected to the control unit and the operation of the aqua stopping device 200 is controlled by the control unit.

The other end of the connecting tube 230 is connected to the water supply connecting port 121 of the air brake 120, to allow wash water to flow through the inside of the connecting tube 230 into the wash compartment. Because the signal wire 270 runs along the inner surface of the outer tube 220 and can extend equally therewith, the signal wire 270 does not pose an obstacle for a user or interfere with other components.

An explanation of the operation of the above aqua stopping device 200 will now be given.

When a leak occurs inside the dishwasher 100, the leaking wash water accumulates at the base of the dishwasher 1OQ When the accumulated leaking water exceeds a predetermined volume, it collects in the vicinity of the leak detector, whereupon the leak detector senses the leak. The leak detector, as previously explained, can be disposed at any location that is prone to leaking.

When the leak detector 400 senses a leak, a leakage signal is relayed to the upper and lower valves 280 and 281 via the signal wire 270 and the connecting wires 271. The upper and lower valves 280 and 281 close according to the leakage signal, closing the passage inside the valve body 21Q Accordingly, wash water no longer flows into the dishwasher 100 and ceases to flow through the leaking area so that the leak stops.

An explanation of the assembly of the above aqua stopping device 200 will now be given.

First, the connecting wire 271 is connected to the signal wire 270, forming the connecting portion 272. Next, the inner case 260 is installed to completely encompass the connecting portion 272. Then, filler 261 is injected inside the inner case 260 to insulate the connecting portion 272 from water that enters the exterior space of the connecting portion 272, namely, the interior of the outer case 25Q

Finally, the outer case 250 protecting the inner case 260 is installed. Here, the inside of the outer case 250 already has the valve body 210 and other components installed therein.

The above assembly process allows only the interior of the inner case 260 to be filled with filler, instead of the conventional filling of the entire interior of the outer case 250 with filler. As a result, the aqua stopping device 200 becomes lighter, and the amount of filler needed decreases, reducing manufacturing cost.

Mode for the Invention

In another embodiment of the present invention, the inner case is not formed as a separate component, but is structurally integrated with the outer case. The signal wire is installed inside the inner case, and filler is injected into the inner case. In this case, current leakage from the connecting portion is prevented. The only difference is that the outer case forms a specific space in a portion of its interior to be injected with filler.

While FIG. 2 shows the inner case attached to the inner wall of the outer case, the inner case may be disposed in suspension anywhere within the inner space of the outer case. However, because the signal wire should be supported by the inner wall of the outer case to prevent movement thereof, the inner case may be coupled to a contacting surface of the outer case.

Furthermore, while the embodiment has two signal wires convening into a single connecting wire at a connecting portion for preventing current leakage, the present invention is not thus limited, and may include a filler injected at a connection between a solenoid valve terminal and a connecting wire or at any region that is susceptible to current leakage.

Also, the present invention can equally be applied to a connecting portion between one connecting wire and one signal wire. However, for the sake of operational reliability of the aqua stopping device, two solenoid valves are used with each having a respective signal wire connected to a connecting wire at a connecting portion disposed inside the inner case, in order to prevent current leakage.

When the inner case can be completely sealed, a separate filler is not required. However, in order to increase the reliability of the product, a filler may be injected into the inner case. A further embodiment includes the omission of the inner case and the use of only the filler to encase the exterior of the connecting portion, in order to prevent current leakage.

### INDUSTRIAL APPLICABILITY

The present invention provides an aqua stopping device having a reduced manufacturing cost and manufacturing time, enabling an increase in production.

Also, the weight of the aqua stopping device is reduced to make the device more manageable by users. Furthermore, in devices such as a dishwasher that sprays water frequently and has complex water passageways, and is therefore prone to leaks in multiple areas, the aqua stopping device of the present invention provides an increased preventative measure for leaks.

1. An aqua stopping device for a washing device, comprising:
a valve body including a passage formed within;
at least one valve for opening and closing the passage;
a signal wire connected to a terminal of the valve;
a connecting wire connected to the signal wire and extending a predetermined distance therefrom;
a connecting portion provided at a portion connecting the signal wire and the connecting wire;
an inner case enclosing at least the connecting portion; and
an outer case provided at an exterior of the inner case.

2. The aqua stopping device according to claim 1, wherein the inner case is attached to an inner surface of the outer case.

3. The aqua stopping device according to claim 1, wherein the inner case includes an interior having a filler injected therein.

4. The aqua stopping device according to claim 1, wherein the connecting portion has a filler injected therearound.

5. The aqua stopping device according to claim 1, further comprising:
a connecting tube attached to a lower portion of the valve body for passing wash water therethrough; and
an outer tube disposed around an exterior of the connecting tube for enclosing the connecting tube.

6. The aqua stopping device according to claim 1, wherein the valve is aligned in plurality along the passage.

7. The aqua stopping device according to claim 1, wherein the connecting portion connects two signal wires to one connecting wire.

8. The aqua stopping device according to claim 1, wherein an interior space of the outer case is empty.

9. The aqua stopping device according to claim 1, wherein the inner case includes an outer surface attached to an inner surface of the outer case.

10. The aqua stopping device according to claim 1, wherein the valve is a solenoid valve.

11. An aqua stopping device for a washing device, comprising:
a valve body including a passage formed within;
at least one solenoid valve for opening and closing the passage;
a signal wire connected to a terminal of the solenoid valve;
a connecting wire connected to the signal wire and extending outward;
a connecting portion formed at a connection of the signal wire and the connecting wire;
a filler for insulating at least the connecting portion from an outside; and
an outer case spaced from the filler and including an empty space inside.

12. The aqua stopping device according to claim 11, further comprising an inner case for providing a space to be filled by the filler.

13. The aqua stopping device according to claim 12, wherein the filler fills an entirety of an interior of the inner case.

14. The aqua stopping device according to claim 12, wherein the inner case includes an exterior defining an empty space with the outer case.

15. The aqua stopping device according to claim 11, wherein the solenoid valve and the signal wire are respectively provided in duplicate.

16. A washing device comprising:
a tub for holding wash water and articles to wash therein for washing the articles to wash;
a connecting tube for supplying water to the tub;
a leak detector provided at an exterior of the tub for detecting leaks; and
an aqua stopping device for operating to block a supply of water according to a detection signal from the leak detector, the aqua stopping device being filled with a filler only at wire connecting portions in an interior thereof, the interior being otherwise empty.

17. The washing device according to claim 16, further comprising:
an inner case including an interior filled with the filler; and
an outer case accommodating the inner case and including an empty interior.

18. A washing device comprising:
a tub for holding wash water and articles to wash therein for washing the articles to wash;
a connecting tube for supplying water to the tub;
a leak detector provided at an exterior of the tub for detecting leaks; and
an aqua stopping device for operating to block a supply of water according to a detection signal from the leak detector; wherein the aqua stopping device includes:
an inner case having a wire connecting portion in an interior thereof for preventing water from contacting the wire connecting portion;
a valve for opening and closing a passage according to the detection signal; and
and an outer case disposed at a distant exterior of the inner case and defining an empty interior space.

19. The washing device according to claim 18, wherein the inner case includes an interior space filled with a filler.
